(19) United States
(12) Patent Application Publication
(10) Pub. No.: US 2024/0305040 A1
(43) Pub. Date: Sep. 12, 2024

(54) Pinch Sleeve Assembly With Locking Feature

(71) Applicant: TE Connectivity Nederland BV, s'Hertogenbosch (NL)

(72) Inventor: Freddy Jean Philip Dendas, S'Hertogenbosch (NL)

(73) Assignee: TE Connectivity Nederland BV, s'Hertogenbosch (NL)

(21) Appl. No.: 18/601,011

(22) Filed: Mar. 11, 2024

(30) Foreign Application Priority Data
Mar. 10, 2023 (EP) 23161314.2

(51) Int. Cl. H01R 13/58; H01R 13/622

(52) U.S. Cl. CPC H01R 13/582; H01R 13/622

(57) ABSTRACT

A pinch sleeve for pinching an electric cable in an electric connector includes a plurality of pinch fingers that extend in an axial direction from a base to a free end and a ring member connecting the bases of the pinch fingers in a circumferential direction extending around the axial direction. The pinch fingers are arranged in the circumferential direction and surround an interior volume that receives the electric cable. The interior volume penetrates the pinch sleeve in the axial direction. The ring member has a plurality of coupling teeth that protrude from the ring member for rotational engagement.

### CROSS-REFERENCE TO RELATED APPLICATIONS

This application claims the benefit of the filing date under 35 U.S.C. § 119(a)-(d) of European Patent Application No. 23161314.2, filed on Mar. 10, 2023.

### FIELD OF THE INVENTION

The invention relates to a pinch sleeve for pinching an electric cable in an electric connector, and an assembly comprising such a pinch sleeve and a housing element of an electric connector. The invention further relates to such an assembly comprising a tightening sleeve.

### BACKGROUND

Pinch sleeves are used for fastening electric cables inside electric connectors. The cables are held by a pinching grip of the pinch sleeve. To tighten the pinch sleeve around the cable—typically the cable insulation—a tightening sleeve is used. The tightening sleeve may be screwed onto a housing part of an electrical connector with the pinch sleeve interposed therebetween.

In general, it is desired that the clamping force of the pinch sleeve does not diminish over time, causing the tightening sleeve or the cable to loosen. It is also important that the pinch sleeve does not damage the cable sheath.

### SUMMARY

A pinch sleeve for pinching an electric cable in an electric connector includes a plurality of pinch fingers that extend in an axial direction from a base to a free end and a ring member connecting the bases of the pinch fingers in a circumferential direction extending around the axial direction. The pinch fingers are arranged in the circumferential direction and surround an interior volume that receives the electric cable. The interior volume penetrates the pinch sleeve in the axial direction. The ring member has a plurality of coupling teeth that protrude from the ring member for rotational engagement.

### BRIEF DESCRIPTION OF THE DRAWINGS

The invention will be described in more detail in the following with reference to exemplary embodiments illustrated in the drawings, in which:

FIG. 1 is a schematic sectional view of an assembly according to an embodiment;

FIG. 2 is a schematic perspective view of a pinch sleeve and a housing element according to an embodiment;

FIG. 3 is a schematic perspective view of a tightening sleeve according to an embodiment;

FIG. 4 is a detail perspective view of a tightening sleeve according to an embodiment; and

FIG. 5 is a perspective view of a pinch sleeve in an engaged state according to an embodiment.

### DETAILED DESCRIPTION OF THE EMBODIMENT(S)

In the following, the invention is explained exemplarily in more detail with reference to the drawings and in accordance with several embodiments, the different features of which can be combined with one another as desired. A feature described in the below embodiments may be omitted if its technical effect is not required in a particular application and, likewise, a feature described herein that is not present in a particular embodiment may be added. In the following, the same reference numerals are used for elements that correspond to each other with respect to at least one of structure and function.

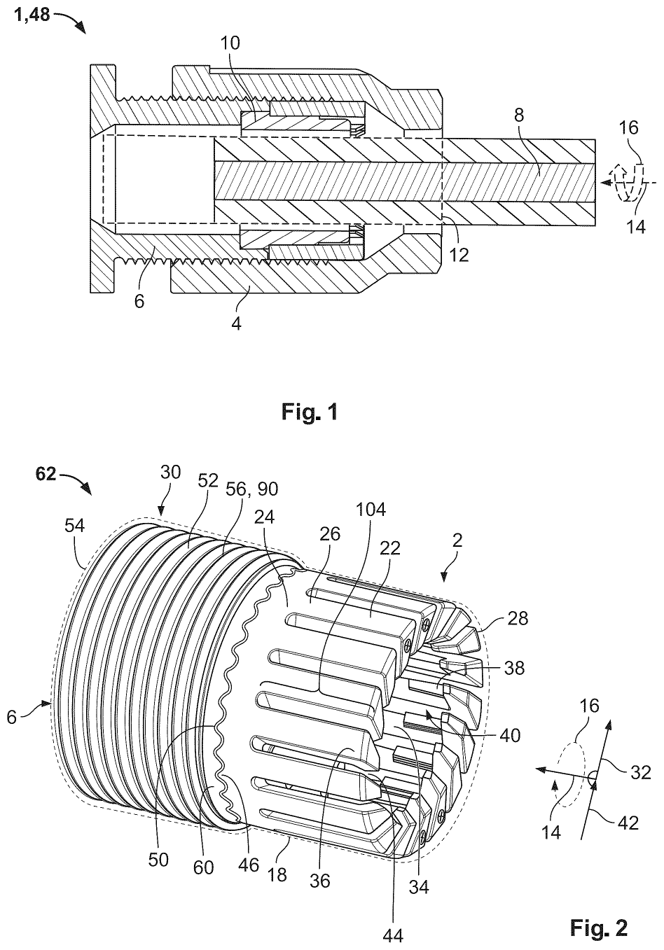

First, the general structure of an assembly 1 according to a possible embodiment of the invention is described with reference to FIG. 1. The assembly 1 comprises a pinch sleeve 2, shown in FIG. 2. The assembly 1 may further comprise a tightening sleeve 4, a housing element 6, an electric cable 8, and a sealing 10, as shown in FIG. 1. All elements of the assembly 1 surround an approximate cylindrical cavity 12 extending in an axial direction 14. The cavity 12 is configured for receiving the electric cable 8.

As shown in FIG. 1, the electric cable 8 may be positioned inside the cavity 12 of the assembly 1 and extend in an axial direction 14 through the assembly 1. Thus, the electric cable 8 is coaxially surrounded by all elements of the assembly 1 in a circumferential direction 16, the circumferential direction 16 extending around the axial direction 14.

The assembly 1 may be used as an electric connector 48.

FIG. 2 shows details of the structure of a pinch sleeve 2. The pinch sleeve 2 has the approximate shape of a cylinder 18, the central axis of the cylinder 18 extending in the axial direction 14. The pinch sleeve 2 comprises pinch fingers 22 and a ring member 24.

Each of the pinch fingers 22 has a base 26 and a free end 28 and extends in the axial direction 14. The pinch fingers 22 are arranged along a circumferential direction 16, the circumferential direction 16 extending around the axial direction 14. Two neighboring pinch fingers 22 may be spaced apart from one another at their bases 26 in the circumferential direction 16. In particular, in a force-free state 30, the pinch fingers 22 may be spaced apart along the entire length. Then, the pinch fingers 22 are parallel to each other and to the axial direction 14.

In an embodiment, at least one of the pinch fingers 22 may overlap at least one neighboring pinch finger 22 in the radial direction 32. The radial direction 32 is perpendicular to the axial direction 14. In particular, an inner section 34 of the pinch finger 22 may overlap an outer section 36 of the neighboring pinch finger 22 in the radial direction 32. The radial direction 32 is perpendicular to the axial direction 14 and to the circumferential direction 16. Analogously, the outer section 36 of the pinch finger 22 may overlap the inner section 34 of the neighboring pinch finger 22. Pinch fingers 22 are regarded as neighboring if located next to each other in the circumferential direction 16.

In an embodiment, the pinch fingers 22 may have side faces, which side faces face in the circumferential direction 16 and are inclined with respect to the radial direction 32. The side faces may be parallel to the axial direction 14. Thereby, the diameter of the cylindrical space enclosed by the pinch fingers 22 is adjustable, allowing cables of a larger span of diameters to be accommodated.

At least some, and in an embodiment all, of the pinch fingers 22 may have a retaining protrusion 38, as shown in FIG. 2. The retaining protrusion 38 protrudes into an interior volume 40 in a radial inward direction 42 and in the axial direction 14. The retaining protrusion 38 may be located at the free ends 28 of the pinch fingers 22. The retaining protrusion 38 may be hook-shaped and/or provide a shoulder with a face facing in the axial direction 14 towards the base 26 of the respective pinch finger 22. The retaining protrusion 38 may be arranged at a free end of the pinch fingers 22.

The retaining protrusion 38 protrudes towards the interior volume 40 of the pinch sleeve 2. The interior volume 40 of the pinch sleeve 2 may be substantially cylindrical and a mantle surface 44 of the interior volume 40 may be defined by the inner sections 34 of the pinch fingers 22. In an embodiment, an inner section 34 of the pinch finger 22 may face the interior volume 40 and an outer section 36 of the pinch finger 22 may face away from the interior volume 40. The pinch fingers 22 may rest on each other and slide with respect to one another, when they are deflected radially inwards.

The pinch sleeve 2 further comprises a ring member 24, shown in FIG. 2. The ring member 24 is located at an end of the pinch sleeve 2 opposite the free ends 28. The ring member 24 connects the bases 26 of the pinch fingers 22 in the circumferential direction 16. For example, the ring member 24 may be connected to the bases 26 of the pinch fingers 22 through material-locking, friction-locking, or form-locking. In an embodiment, the ring member 24 and the pinch finger 22 may be formed monolithically.

The ring member 24 has a plurality of coupling teeth 46, which protrude from the ring member 24 as shown in FIG. 2. The coupling teeth 46 are provided for rotational engagement with another element of the electric connector 48 as is described further below. The coupling teeth 46 may be at least partially rounded. In particular, the roundings can be sinusoidal in shape. Additionally and/or cumulatively, the coupling teeth 46 may also be at least partially pointed, e.g. tooth-like. In an embodiment, the coupling teeth 46 may be located at an end face 50 of the ring member 24. The end face 50 faces away from the pinch fingers 22 along the axial direction 14. The coupling teeth 46 protrude away from the pinch fingers 22 along the axial direction 14. In an embodiment, the ring member 24 may have a thin wall, saving space in the radial direction 32. In an alternative or cumulative embodiment, the coupling teeth 46 may be arranged on a circumferential surface of the ring member 24 and protrude radially inwards and/or outwards from the ring member 24.

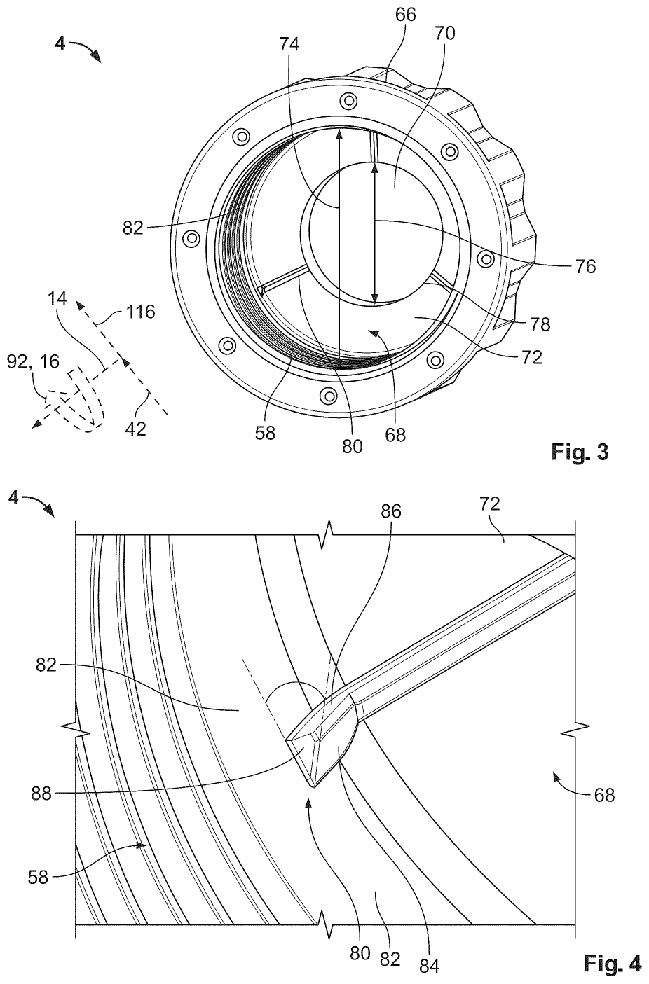

The housing element 6 is approximately cylindrical, as shown in FIG. 2. A lateral surface 52 of the housing cylinder 54 has a housing thread 56 that is provided to engage a screw thread 58 of a tightening sleeve 4, shown in FIG. 3. The housing thread 56 is a complementary thread to the thread of the screw thread 58. The housing thread 56 may, in one example, be an external thread and the screw thread 58 may be an internal thread.

The housing element 6 has a plurality of complimentary coupling teeth 60. The complimentary coupling teeth 60 are shaped complementary to the coupling teeth 46 of the pinch sleeve 2. The complementary coupling teeth 60 are configured to engage the coupling teeth 46 of the pinch sleeve 2. In conformity with the coupling teeth 46 of the pinch sleeve 2, the complementary coupling teeth 60 may be at least partially rounded. In particular, the roundings may be sinusoidal in shape. Additionally and/or cumulatively, the coupling teeth 46 may also be at least partially pointed.

When the housing element 6 and the pinch sleeve 2 are in an engaged state 62, as shown in FIG. 2, the coupling teeth 46 and the complementary coupling teeth 60 may form a coupling, which is torsionally and additionally or cumulatively rotationally stiff. The housing element 6 encloses a cable volume for receiving the electric cable 8. In the assembled state, the cable volume and the interior volume 40 may form a continuous volume. The central axis 20 of the continuous volume extends in the axial direction 14.

In the following, the structure of the tightening sleeve 4 according to a possible embodiment of the invention is described with reference to FIGS. 3 and 4.

The tightening sleeve 4 has approximately the shape of a hollow cylinder 66. In the inside of the hollow cylinder 66, a receptacle 68 is located that is configured to receive the pinch sleeve 2 at least partially, and in an embodiment in its entirety. The pinch sleeve 2 may be inserted into the receptacle 68 in the axial direction 14. In an embodiment, the length of the receptacle 68 may be larger than the length of the pinch sleeve 2 in the axial direction 14. Further, the tightening sleeve 4 comprises a cable opening 70 for the electric cable 8. In an embodiment, the cable opening 70 may be opposite the receptacle 68. The cable opening 70 may be continuous with the receptacle 68.

The tightening sleeve 4 further comprises a bevel 72 that extends in the circumferential direction 16, as shown in FIG. 3, and may be configured to abut the free ends 28 of the pinch fingers 22. In an embodiment, the bevel 72 may be frusto-conical. The bevel 72 may taper in the axial direction away from the pinch sleeve 2 and/or towards the cable opening 70. In an embodiment, an inner width of the receptacle 74 may be larger than the inner width of the cable opening 76. In this case, the bevel 72 may taper from the inner width of the receptacle 74 to the inner width of the cable opening 70. In another embodiment, the rim 78 of the cable opening 70 may be continuous with the bevel 72.

The tightening sleeve 4 further comprises at least one driver 80. The driver 80 may be located on an inner wall 82 of receptacle 68 and protrudes in the axial direction 14 and the radial inward direction 42. The driver 80 may extend in the axial direction 14 along the bevel 72. The driver 80 may have a saw-tooth cross-section in a plane perpendicular to the axial direction 14.

As shown in FIG. 4, the driver 80 comprises a first face 84 and a second face 86. The first face 84 faces in the circumferential direction 16. The second face 86 is located opposite to the first face 84. The second face 86 may be perpendicular to the circumferential direction 16. The first face 84 has a lower inclination 88 with respect to the circumferential direction 16 than the second face 86. The driver 80 may be shaped as a rib.

The number of drivers 80 may be adapted to the cable diameter and the size of the tightening sleeve 4. One, two, three or more drivers 80 may be provided. If a plurality of drivers 80 is provided, they may be arranged at equal distances in the circumferential direction 16.

In the following, the functionality of an assembly 1 according to a possible embodiment is explained with reference to FIGS. 1 to 5. Thereby, the interaction of the above-described components of the electric connector 48 is described exemplarily.

First, the electric cable 8 is positioned inside the cavity 12 of the assembly 1, as shown in FIG. 1. The electric cable 8 penetrates a cable volume of the housing element 6, the interior volume 40 of the pinch sleeve 2 and the receptacle 68 of the tightening sleeve 4. The electric cable 8 extends along the axial direction 14. It is coaxially surrounded by all elements of the assembly 1 in the circumferential direction 16.

Next, the tightening sleeve 4 is mounted on the housing element 6, such that the screw thread 58 of the tightening sleeve 4 engages the outer thread 90 of the housing element 6. In doing so, the pinch sleeve 2 enters into the receptacle 68 of the tightening sleeve 4. The drivers 80 of the tightening sleeve 4 are each positioned automatically between neighboring pinch fingers 22.

In an embodiment, the driver 80 may be configured to engage or be inserted radially between two neighboring pinch fingers 22 at at least one of (1) the free ends 28 of the two neighboring pinch fingers 22 and a location between the free end 28, and (2) the base 26 of the two neighboring pinch fingers 22. An engagement of the driver 80 at the free ends 28 of the pinch fingers 22 allows the pinch fingers 22 in the circumferential direction 16 to be bent. This may improve the formation of a circumferentially closed ring around the cable by the free ends 28, which in turn, avoids an only punctual pinch onto the cable 8 by the pinch fingers 22. Optionally, the driver 80 may be configured to engage axially between two neighboring pinch fingers 22 at an end face of the pinch fingers 22, the end face facing away from the ring member 24 in the axial direction 14.

For tightening, the tightening sleeve 4 is rotated in the direction of its handedness 92, so that the tightening sleeve 4 is moved in an axial direction 14 relative to the pinch sleeve 2. After the tightening sleeve 4 has moved a certain distance in the axial direction 14, the bevel 72 abuts against the free ends of the pinch fingers 22. Thereby, the bevel 72 and the free ends 28 of the pinch fingers 22 are frictionally engaged and the bevel 72 exerts a bevel force on the free ends 28 of the pinch fingers 22. The bevel force comprises a radial bevel force component, an axial bevel force component and a circumferential bevel force component. The radial bevel force component points in the radial inward direction 42, the axial bevel force component points in the axial direction 14, and the circumferential bevel force component points in the circumferential direction 16. In particular, the circumferential bevel force component points in the direction of the handedness 92 of the tightening sleeve 4.

The radial bevel force component causes the free ends 28 of the pinch fingers 22 to be deflected in a radial inward direction 42. The free ends 28 of the pinch fingers 22 are thus pushed into the sealing 10, which surrounds the electric cable 8. When no sealing 10 is provided, the free ends 28 of the pinch fingers 22 may also be pushed directly into the electric cable 8. Due to the normal force exerted on the electric cable 8, the electric cable 8 is fastened inside the assembly 1.

The axial bevel force component causes the pinch sleeve 2 to be pushed against the housing element 6. As the pinch sleeve 2 is pushed against the housing element 6, the coupling teeth 46 of the pinch sleeve 2 frictionally engage the complementary coupling teeth 60 of the housing element 6, thus preventing relative rotational movement between the housing element 6 and the pinch sleeve 2. As the housing element 6 is immovable in the circumferential direction 16, a rotation of the pinch sleeve 2 is locked in and against the circumferential direction 16.

The circumferential bevel force component causes the free ends 28 of the pinch fingers 22 to be deflected in a circumferential direction 16. Moreover, the at least one driver 80 engages between two neighboring pinch fingers 22 at an axial location 104. The axial location 104 is located between the bases 26 and the free ends 28 of the pinch fingers 22. As the tightening sleeve 4 is rotated in the direction of its handedness 92, the first face 84 of the at least one driver 80 comes into contact with the pinch fingers 22 at the axial location 104. Thereby, the first faces 84 of the drivers 80 and the pinch fingers 22 are frictionally engaged and the first faces 84 of the drivers 80 exert a driver force on the pinch fingers 22. The driver force has a circumferential driver force component, a radial driver force component and an axial driver force component. The circumferential driver force component acts in the circumferential direction 16, more precisely in the direction of the handedness 92 of the tightening sleeve 4. The radial driver force component acts in the radial inward direction 42 and the axial driver force component acts in the axial direction 14.

The circumferential driver force component causes the pinch fingers 22 to be deflected in a circumferential direction 16, the radial driver force component causes the pinch fingers 22 to be deflected in the radial inward direction 42. The axial driver force component causes the pinch sleeve 2 to be pushed against the housing element 6. The deflection of the pinch fingers 22 caused by the driver force may be at its maximum at the axial location 104 where the drivers 80 get into contact with the pinch fingers 22. Further, the pinch fingers 22 may be torsionally distorted between the bases 26 and the axial location 104 where the drivers 80 are in contact with the pinch fingers 22.

When turning the tightening sleeve 4, the pinch fingers 22 continue to move along the first faces 84 of the drivers 80. When the axial locations 104 of the outer sections 36 of the pinch fingers 22 have passed the radially most inward portion of the drivers 80, the driver force no longer is exerted on the pinch fingers 22 at the axial location 104 of the pinch fingers 22. As a result, the pinch fingers 22 snap back in the radial outward direction 116 at the axial location 104. The drivers 80 then again engage between two neighboring pinch fingers 22 at an axial location 104.

The snapping of the pinch fingers 22 occurs each time a driver 80 has overpassed a pinch finger 22 and engages between the next two neighboring pinch fingers 22. Due to this, a user may receive haptic feedback resembling the feedback from a ratchet during tightening the tightening sleeve 4.

In case the tightening sleeve 4 is rotated backwards against the direction of its handedness 92, the second faces 86 of the drivers 80 come into contact with the retaining protrusions 38 that protrude towards the interior volume 40 of the pinch fingers 22. As the second faces 86 of the drivers 80 are parallel to the retaining protrusion faces, the second faces 86 of the drivers 80 only exert a force in a circumferential direction 16. Thereby, the pinch fingers 22 cannot be deflected in a radial inward direction 42 so that the drivers 80 cannot pass over—or require a high torque to pass over—a pinch finger 22 against the direction of the handedness 92. As the pinch sleeve 2 is unable to rotate backwards due to the rotationally stiff coupling with the housing element 6, also the tightening sleeve 4 cannot rotate backwards.

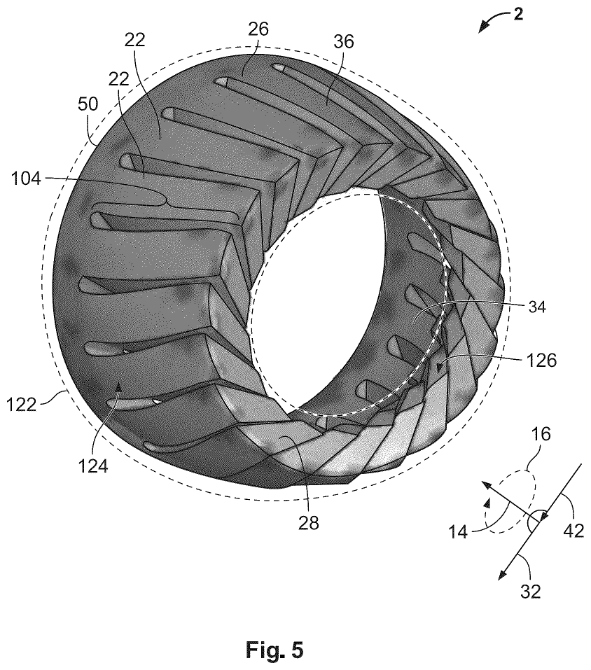

During tightening, the forces exerted, from the bevel 72 to the free ends 28 of the pinch fingers 22 and from the drivers 80 to the pinch fingers 22, cause a deformation of the pinch sleeve 2. Before tightening, in a force-free state 30, the pinch sleeve 2 has the shape of a cylinder 18. During tightening, in a loaded state 120, the pinch sleeve 2 approximately assumes the shape of a frustocone 122 as shown in FIG. 5, i.e. the diameter of the pinch sleeve 2 tapers in the axial direction.

The ring member 24 is located at the first end of the frustocone 122. The ring member 24 does not change its shape during tightening. At the second end of the frustocone 122, the free ends 28 of the pinch fingers 22 are located. In the loaded state 120, the pinch fingers 22 extend helically along the lateral surface of the frustocone 124. In particular, the free ends 28 of the pinch fingers 22 may abut each other in the circumferential direction 16 forming a continuous annular surface 126. After tightening, the continuous annular surface 126 has contact with the sealing 10 and respectively or cumulatively with the electric cable 8. Thereby, an even pressure between the continuous annular surface 126 and the cable 8, which is inserted into the electric connector, is ensured, preventing possible damage and plastic deformation to the pinched cable sheath

When tightening of the assembly 1 is completed, the normal force 102 exerted from the free ends 28 on the electric cable 8 holds the electric cable 8 inside the assembly 1. Even if the electric cable 8 relaxes over time so that the normal force between the electric cable 8 and the pinch fingers 22 decreases, the tightening sleeve 4 is still prevented from loosening. This is due to the fact that the drivers 80 and the coupling teeth lock a backwards rotation with respect to the housing of the connector.

As a result, a stable and permanent fixation of the electric cable 8 in the assembly 1 is ensured.

What is claimed is:

1. A pinch sleeve for pinching an electric cable in an electric connector, comprising:
a plurality of pinch fingers that extend in an axial direction from a base to a free end, the pinch fingers are arranged in a circumferential direction extending around the axial direction, the pinch fingers surround an interior volume that receives the electric cable, the interior volume penetrates the pinch sleeve in the axial direction; and
a ring member connecting the bases of the pinch fingers in the circumferential direction, the ring member has a plurality of coupling teeth that protrude from the ring member for rotational engagement.

2. The pinch sleeve of claim 1, wherein the ring member has an end face facing away from the pinch fingers along the axial direction, the end face has the coupling teeth that protrude along the axial direction away from the pinch fingers.

3. The pinch sleeve of claim 1, wherein at least one of the pinch fingers overlaps a neighboring pinch finger of the plurality of pinch fingers in a radial direction perpendicular to the axial direction.

4. The pinch sleeve of claim 1, wherein at least one of the pinch fingers has a retaining protrusion that protrudes toward the interior volume.

5. An assembly, comprising:
a pinch sleeve including a plurality of pinch fingers that extend in an axial direction from a base to a free end and a ring member connecting the bases of the pinch fingers in a circumferential direction extending around the axial direction, the pinch fingers are arranged in the circumferential direction, the pinch fingers surround an interior volume that receives the electric cable, the interior volume penetrates the pinch sleeve in the axial direction, the ring member has a plurality of coupling teeth that protrude from the ring member for rotational engagement.

6. The assembly of claim 5, further comprising a housing element of an electric connector having a plurality of complementary coupling teeth engaging the coupling teeth of the pinch sleeve.

7. The assembly of claim 5, further comprising a tightening sleeve having a bevel, the bevel abuts the free ends of the pinch fingers.

8. The assembly of claim 7, wherein the tightening sleeve has a driver that engages between a pair of neighboring pinch fingers of the plurality of pinch fingers.

9. The assembly of claim 8, wherein the driver engages between the free end of one of the neighboring pinch fingers and a location between the free end and the base of the other of the neighboring pinch fingers.

10. The assembly of claim 8, wherein the driver protrudes from the tightening sleeve in at least one of the axial direction and a radial inward direction.

11. The assembly of claim 8, wherein the driver extends in the axial direction along the bevel.

12. The assembly of claim 8, wherein the tightening sleeve has a receptacle receiving the pinch fingers in the axial direction.

13. The assembly of claim 12, wherein the receptacle has a cylindrical inner wall, the driver is on the cylindrical inner wall.

14. The assembly of claim 8, wherein the driver has a first face facing in the circumferential direction and a second face opposite the first face.

15. The assembly of claim 14, wherein the first face has a lower inclination with respect to the circumferential direction than the second face.

16. The assembly of claim 14, wherein the tightening sleeve has a screw thread with a handedness and the first face faces in the direction of the handedness.

17. An electric connector, comprising:
a pinch sleeve including a plurality of pinch fingers that extend in an axial direction from a base to a free end and a ring member connecting the bases of the pinch fingers in a circumferential direction extending around the axial direction, the pinch fingers are arranged in the circumferential direction, the pinch fingers surround an interior volume that receives the electric cable, the interior volume penetrates the pinch sleeve in the axial direction, the ring member has a plurality of coupling teeth that protrude from the ring member for rotational engagement;
a housing element of an electric connector having a plurality of complementary coupling teeth engaging the coupling teeth of the pinch sleeve; and
a tightening device having a driver extending between a pair of neighboring pinch fingers of the plurality of pinch fingers.

18. The electric connector of claim 17, wherein the pinch fingers are torsionally distorted between the base and an axial location at which the driver engages between the pair of neighboring pinch fingers.

19. The electric connector of claim 17, wherein the pinch fingers abut each other in the circumferential direction.

20. The electric connector of claim 19, wherein the pinch fingers form a continuous annular surface that faces the interior volume.
